(19) United States
(12) Patent Application Publication
(10) Pub. No.: US 2010/0287816 A1
(43) Pub. Date: Nov. 18, 2010

(54) Insect trap

(75) Inventor: Kevin G. Abelbeck, Fort Collins, CO (US)

Correspondence Address: Kevin Abelbeck, 1230 Twinberry Court, Fort Collins, CO, 80525, US

(73) Assignee: Abelbeck Partners, Ltd., Fort Collins, CO (US)

(21) Appl. No.: 12/454,462

(22) Filed: May 18, 2009

(51) Int. Cl. A01M 1/10; A01M 1/14; A01M 1/04; A01M 1/02; A01M 1/08

(52) U.S. Cl. 43/113; 43/107; 43/114; 43/139

(57) ABSTRACT

A flying insect trap uses one or more attractants desirable to a particular insect, such as many species of mosquitoes. The insect trap uses a carbonic compound and an acid to produce carbon dioxide with water vapor thereby also providing some airborne acid. The chemicals are combined in a liquid trap to which airflow is directed. A fan or other airflow generator provides the wind. The device has an intake port and an exhaust vent. The intake port may be positioned directly above the exhaust vent. A light, such as a light emitting diode (LED) is positioned near the intake port. This illuminates the intake port, the light being another mosquito attractant. The color of the light may be a variety of colors such as blue or green but may also be white. A second trap in the form of a glue trap may also be used. This trap may include a sticky surface where airflow is also directed. The liquid trap provides an acidic and watery capture for the vacuumed insects and the glue trap is the second trap. Those that happen to avoid both traps are run through the fan. Exhausted gasses of carbon dioxide, one or more of specific acids and water vapor exhaust near the intake to lure mosquitoes to the area. The light and wind are also attractants. The mosquitoes are then drawn into the intake port by the wind from the fan and directed toward one or more of the traps.

### FIELD OF THE INVENTION

The present invention generally relates to insect traps. More specifically, the present invention relates to devices that catch mosquitoes.

### BACKGROUND OF THE INVENTION

Flying insects, especially mosquitoes are not only annoying but potentially life threatening. Mosquitoes have been shown to transmit dozens of diseases including elephantiasis, malaria and yellow fever. The Center for Disease Control (CDC) reported over 1350 human cases of West Nile Virus in the U.S. in 2008. Of those cases reported to the CDC, there were 24 deaths. According to Gordon Edwards (21^{st} Century Science & Technology Magazine, Fall 2002) malaria kills 2-3 million people a year. These mosquito-borne viruses have plagued mankind since ancient Egypt. Therefore combating and controlling the mosquito population is critically important even today in the age of technology and pesticides, in our country and around the world.

Pesticides such as DDT do kill the pests but any chemical designed to kill an animal of any sort can have potentially detrimental effects on a human as well. Another result of mass destruction of a species by chemical means is those few that survive due to a genetic resistance will now multiply rapidly in the face of minimal competition for food. This new race will be genetically predisposed to be resistant or immune to the chemical that killed their ancestors, thus rendering the chemical agent ineffective. An alternative action is to eliminate the pests by capturing them before they have a chance to reproduce. The female mosquito is the only gender that feeds on mammalian blood. Therefore this gender need only be targeted.

An attractant or series of attractants may be used to lure the mosquito into a trap, thus providing a snare from which they are unable to escape. Such a snare is harmless to humans, pets, birds and other larger animals. Some snares exist on the market, but most burn propane or other fossil fuels to produce carbon dioxide (the major attractant for mosquitoes). This precludes operation in a building, provides a danger of fire, and is considerably expensive to manufacture. Many of these items cost well over one thousand dollars to the consumer and are therefore out of financial reach for a large portion of the population.

It should, therefore, be appreciated that there is a need for an insect trap that is safe to be used indoors, is inexpensive to produce and has minimal impact on other species not targeted by the trap. The present invention fulfills this need and others.

### SUMMARY OF THE INVENTION

The invention is an insect snare, which may entice and capture insects using a carbonic mixture in a liquid trap. A frame supports the liquid trap. The frame includes an intake port and an exhaust vent. An airflow generator may be used to provide airflow from the intake port to the exhaust vent. The liquid trap may include a solution with a pH less than 7.0 or preferably less than 4.0 that reacts with the carbonic mixture. The liquid trap may alternatively include a solution comprised of water with the carbonic mixture including an anhydrous acid, the mixture placed in the water to release carbon dioxide and water vapor into the airflow. The acid may be an acid selected from the group consisting of lactic acid, pyruvic acid, citric acid, oxaloacetic acid, 7-octenoic acid and 2-oxopentanoic acid. The carbonic mixture may include a compound such as sodium carbonate, sodium bicarbonate or calcium carbonate. In one form the carbonic mixture may be comprised of sodium bicarbonate and lactic acid. This mixture is preferably comprised of between 168 grams and 188 grams of lactic acid and between 156 grams and 176 grams of sodium bicarbonate. The invention may include a carbonic mixture which is comprised of 178 grams of lactic acid and 166 grams of sodium bicarbonate. The carbonic compound and the anhydrous acid may be compressed to form a tablet. The tablet may react with water at 21 degrees Celsius and one atmosphere of pressure for a substantially continuous period of at least 2 hours and up to 4 hours.

In the structure of the device the intake port may be positioned substantially above the exhaust vent. The airflow within the device may be directed substantially toward the liquid trap. The device may also include a glue trap with an adhesive surface. In this case, the airflow may be directed substantially toward the adhesive surface. When two unique traps, such as water and adhesive are used, the airflow may be directed toward both traps independently between the intake port and the exhaust vent. The airflow generator may be comprised of a fan such as a direct current (DC) electric fan. The device may also include a light positioned substantially near the intake port. This light may be a light emitting diode (LED). The color of the light may be white, green or blue.

An exemplary method for catching mosquitoes according to the invention, including providing a device as disclosed and including the steps of combining a specified liquid and the carbonic mixture in the liquid trap; placing the liquid trap in the frame of the device and actuating the airflow generator. When the device includes a light, the method may also include the step of illuminating the light.

For purposes of summarizing the invention and the advantages achieved over the prior art, certain advantages of the invention have been described herein. Of course, it is to be understood that not necessarily all such advantages can be achieved in accordance with any particular embodiment of the invention. Thus, for example, those skilled in the art will recognize that the invention can be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following description of the preferred embodiments and drawings, the invention not being limited to any particular preferred embodiment(s) disclosed.

### BRIEF DESCRIPTION OF THE DRAWINGS

Embodiments of the present invention will now be described, by way of example only, with reference to the following drawings, in which:

FIG. 1 is an isometric view of a flying insect trap, shown fully assembled, the device produced in accordance with a version of the present invention.

FIG. 2 is a side view of a flying insect trap with the cup displaced and showing the internal structure of the device of FIG. 1.

FIG. 3 is a side view of the flying insect trap of FIG. 2 showing flow and operation of the device.

FIG. 4 is an isometric view of the flying insect trap of FIG. 2 with half of the frame removed.

FIG. 5 is an isometric view of a cup of the flying insect trap of FIG. 1 shown with the tablet and splash ring displaced.

FIG. 6 is a partially disassembled isometric view of the flying insect trap of FIG. 1, with the frame, batteries and battery door displaced.

FIG. 7 is a displaced isometric view of an alternative cup and replaceable bag with reactants of the flying insect trap of FIG. 1.

FIG. 8 is an isometric view of an alternative cup with the bag assembled to the top cap, the cup and associated parts of the flying insect trap of FIG. 1.

For the most part, and as will be apparent when referring to the figures, when an item is used unchanged in more than one figure, it is identified by the same alphanumeric reference indicator in all figures

### DETAILED DESCRIPTION OF THE INVENTION

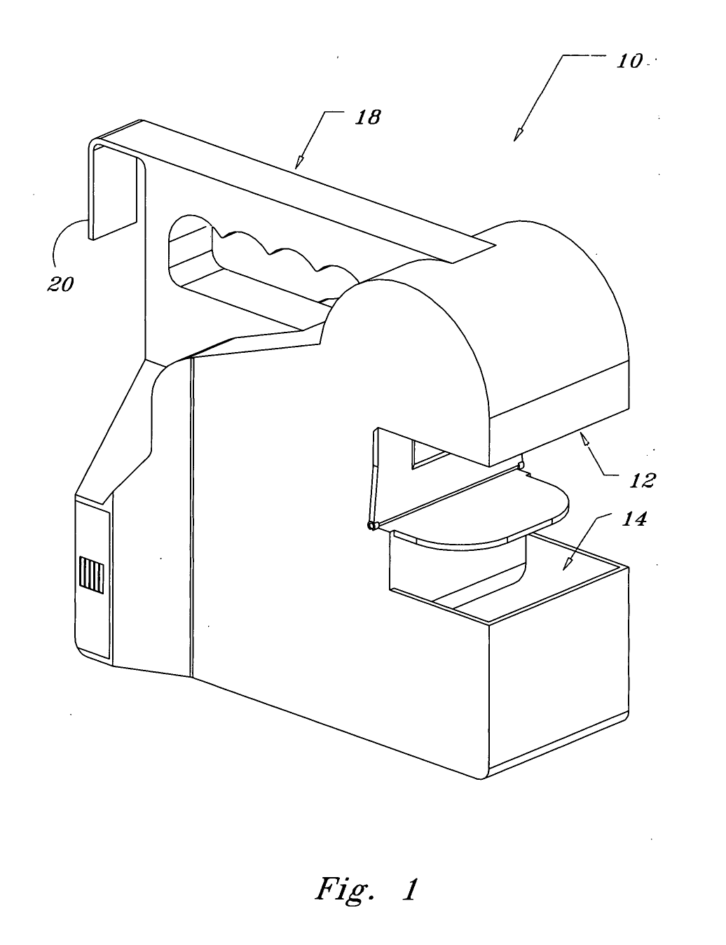

With reference to the illustrative drawings, and particularly to FIG. 1, there is shown the present invention as a flying insect trap especially for use with mosquitoes or other flying insects. For the purposes of this disclosure the term “mosquito” will be used though it is understood that it applies to other flying insects as well. The device may use five categories of attractants to lure mosquitoes into a watery, sticky or “cutting” death. The primary attractants may be: 1) carbon dioxide (CO₂); 2) light; 3) water vapor (humidity); 4) some form of acid such as lactic acid; and 5) wind currents. Each of these is associated with humans or other mammalian “meals” to the airborne bloodsuckers. Humans and other mammals exhale carbon dioxide (CO₂), water vapor and acids such as lactic acid come from our breath and in the perspiration through our skin. We create wind currents every time we move and speak and after dark we are seldom not around some sort of light. As such, mosquitoes have associated these stimuli with a potential meal.

Referring to the drawings, FIG. 1 shows a device 10 in its fully assembled state. Though some details of the appearance are not critical, the general layout illustrates some of the unique features. The opening area is comprised of two separate openings, an intake port 12 and an exhaust vent 14. The exhaust vent 14 may be positioned below the intake port 12. This is done for two reasons. First, research suggests that mosquitoes will instinctively fly up when they sense a wind current. It is therefore advantageous to position the intake 12 of the device 10 above a turbulent air area, especially one containing additional attractants to the mosquitoes. The second advantage is when the mosquito enters the device 10, wind currents force the mosquito down with the assistance of gravity into one or more traps. By positioning the mosquito's entrance at a higher level, more opportunities exist to “throw” the mosquito down with the aid of gravity while in the device 10. Between the intake port 12 and the exhaust vent 14 may be provided a table 16. The table 16 provides a steady surface to support the cup (not seen) to be loaded into the device 10 and offers a means of deflection of the gasses flowing up out of the exhaust vent 14. This deflection creates a “cloud” filled with mosquito attractants to lure the mosquitoes to the device 10.

On the top of the device 10, rearward to the intake port 12, is a handle 18 which may include a hook 20 on the far end. The handle 18 assists in the portability of the device 10 and aids in the placement of the device 10 in a mosquito prone area. The hook 20 offers a means to support the device 10 on a fence, tree branch or other physical structure. As shown here, the hook 20 may be located on an opposite end of the device 10 from the intake port 12. This may be done in that this form of the device 10 is intended to be directional. That means the mosquitoes are directed toward the device 10 primarily from one general direction. This is desirable in that mosquitoes have a short distance from their birthplace to their feeding territory, unless carried by the wind. Mosquitoes therefore have a relatively small feeding territory when relying on their own flight capability. Therefore, to draw mosquitoes over from the neighbor's yard into yours is counterproductive to the guests during an outdoor barbeque or other gathering. The optimal situation is to draw your mosquitoes over to the device 10, which is located near the outlining regions of the inhabited area of your property. All mosquitoes close to that area will be drawn over by the chemical attractants but with the directional device, more attractants are provided toward a specified direction, therefore it will be less likely to draw mosquitoes from a great distance into your area. This directional feature is not mandatory to the novelty of the invention and is not intended to be inclusive of all forms of the invention.

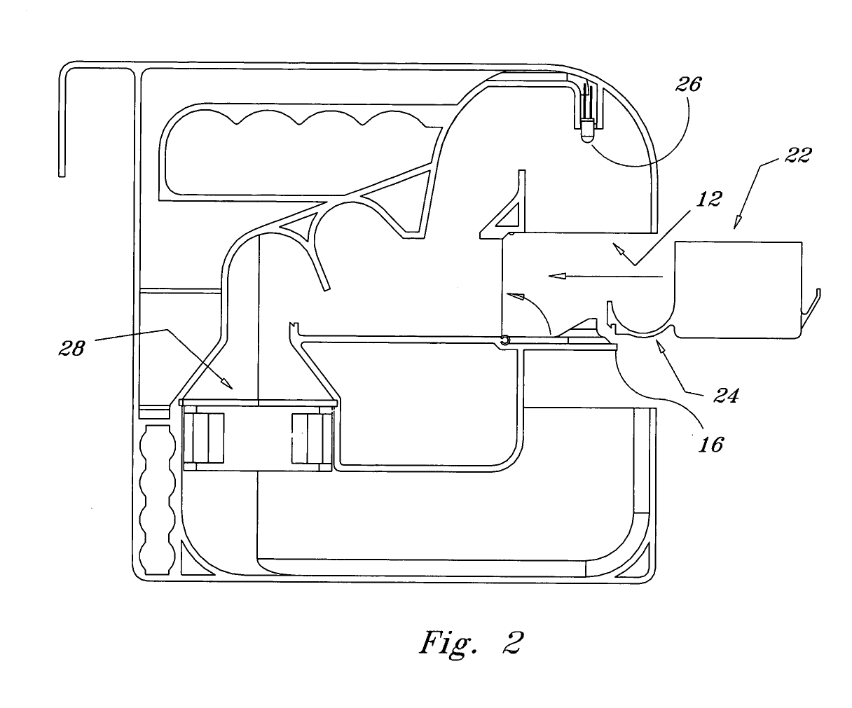

The layout of the interior of the device 10 is shown in FIG. 2. This shows a cup 22 with a “J” shaped base 24 on one end. The cup 22 is a single component that may have several functions. One function is that of a liquid trap and receiver for an attractant tablet including a carbonic mixture. The attractant tablet may be comprised of a carbonic compound of a carbon base including sodium carbonate, sodium bicarbonate or calcium carbonate. An acid may be provided with the tablet either in a dry form or it may be added in a liquid or aqueous form to the carbonic mixture. If a liquid acid is used, the reaction between the carbonic compound and the acid begins when the acid is added to the carbonic compound. The reaction yields a carbon based precipitant, carbon dioxide gas and water. A dry acid can be added to the carbonic compound and water is added to start the reaction. In either case the bubbling gas places some water vapor in the air as well as some trace amounts of the acid used in the reaction. A compressed “tablet” including both the carbonic compound and dry or anhydrous acid may be used. In that case, the user need only add water to start the reaction.

As previously noted, many carbonic compounds may be used. These are bases (pH greater than 7.0) that react with the acid (pH less than 7.0) in a solution to produce the attractants carbon dioxide and water. One example is using lactic acid (C₃H₆O₃) and sodium bicarbonate (NaHCO₃) as the acid and base respectively. The mixture can be compressed into a tablet to prolong the reaction in water to give off the CO₂+water+acid in air continuously for a prolonged period such as at least 2 hours and preferably at least 4 hours.

Mosquitoes are attracted to these chemicals in the air because it suggests the presence of a person or other mammal. That means a potential blood meal for the mosquito. In order to optimize the effectiveness of the device 10 the amount of CO₂ produced by the reaction may be important in that we are trying to simulate a human. The calculated amount of CO₂ a 150-pound (68.2 Kg) person would emit at rest with a typical diet, at a typical Respiratory Exchange Ratio value of 0.83 at one MET (metabolic equivalent) of activity is 198 ml CO₂/min. The body would consume 238.6 ml O₂/min to produce this 198 ml of carbon dioxide. Over 4 hours the amount of CO₂ expired by a person would be 47.5 liters of CO₂. Four hours is used as an optimal situation in that a typical evening outside would not likely last beyond 4 hours.

Using the reactants of lactic acid and sodium bicarbonate, as previously noted would yield the following chemical reaction:

C₃H₆O₃ (aq)+NaHCO₃ (aq)→C₃H₅O₃Na (s)+H₂O (l)+CO₂ (g).

The acid can be liquid, or dry and the combination placed in water. The later will be used though it is understood that both version are viable. The lactic acid (C₃H₆O₃) and sodium bicarbonate (NaHCO₃) are noted as aqueous because when they mix with the water they react. When they are dry they do not, therefore only the surface of the tablet is aqueous and reacting. Lactic acid has a mass of 90.08 g/mol; sodium bicarbonate is 84.02 g/mol and CO₂ is 44.01 g/mol. The density of CO₂ is 0.1144 lb/cu-ft or 1.832 g/L. Therefore 1.832 g/L*47.5 L of CO₂=87.04 g of CO₂ per 4 hours. At 44.01 g CO₂/mol that is 1.978 mol of CO₂/4 hours. Since one mole of each reactant is needed to produce one mole of CO₂, we need 1.978 moles of lactic acid and the same of sodium bicarbonate or 178 g of lactic acid and 166 g of sodium bicarbonate. Without any filler, this is a 344 gram (12.13 ounce) tablet. The compound can be pressed to form a tablet that it will take 4 hours to dissolve in room temperature water (21 degrees Celsius at one atmosphere of pressure). These numbers reflect a calculated 4 hour CO₂ delivery. This period is not mandatory and it is understood that any period of time for the reaction may be used.

Referring to FIG. 2 the first trap is this liquid bath of the acid and base reactants in water or another liquid medium as may be located in the cup 22. The reaction yields a slightly acidic liquid. The pH for lactic acid is 3.86 and therefore using the molar ratio (166/178);

pH=3.86+log(0.9325)=3.83

yields a pH of 3.83. This is acidic considering distilled water is 7.0, but cranberry juice has a pH of 3.5 and lemon juice can have a pH as low as 2.3. The mosquitoes will drown in the cup of acid, but it will not hurt a person if the solution comes into contact with their skin.

Some other specific acids are desirable for attracting mosquitoes, likely because they are found in human sweat. Some of the most appealing acids to several species of mosquitoes include oxo-carboxylic acids, particularly 2-oxopentanoic acid. Also carboxylic acids and 7-octenoic acid have shown a similar threshold sensitivity to the olfactory stimulant 1-octen-3-ol. The carboxylic acid 7-octenoic acid with CO₂ has been shown to be effective in increasing the field test trap catch over CO₂ alone. Desirable acid choices may be 7-octenoic acid and 2-oxopentanoic acid. Lactic acid is commercially available and has also been shown as effective as a successful mosquito attractant.

The J-shaped base 24 shown in FIG. 2 may be used to provide a support for a glue trap, and will be illustrated in the subsequent drawings. A two-sided tape may be used with one side stuck to the J-shaped base 24 of the cup 22 and the other to catch the mosquitoes which do not fall in the solution in the cup 22. The cup 22 with the glue and carbonic mixture inside may be provided together as a replacement cartridge. The user can add the specified liquid in the cup 22 and expose the adhesive on the J-shaped base 24. This may be inserted into the device 10, then closing the door and turning on the device 10.

A light 26 may be provided in the form of a light emitting diode (LED). This illuminates the intake port 12 and the light is another attractant to mosquitoes. Though white light may be used, blue and green lights have been shown to be effective in attracting mosquitoes. The power of the light can vary but research has suggested using a light of approximately 5000 micro-candle (mcd). The other major component in the device 10 is a fan 28. The fan 28 can take a variety of forms including an electric fan that is driven on direct current (DC) power. A desirable fan may provide at least 20-24 cubic feet per minute (CFM) at 0 psi.

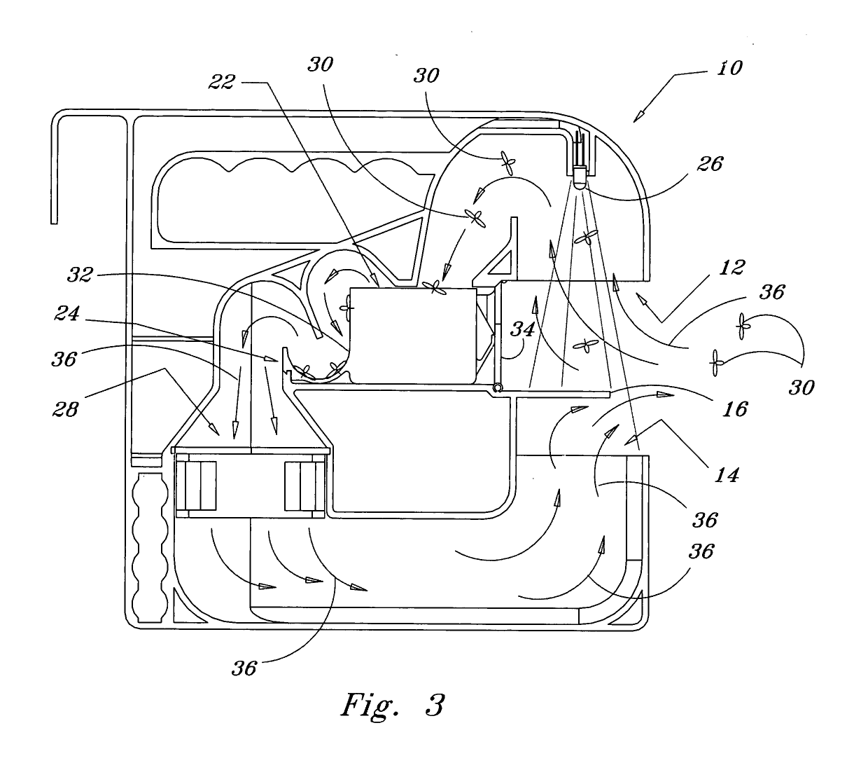

The device 10 in use is shown in FIG. 3. The light 26 is positioned near the intake 12 and the CO₂, water vapor and other airborne components come out the exhaust vent 14, generating an attracting cloud for the mosquitoes 30. The mosquitoes 30 sense the wind current created by the fan 28 as evident at the exhaust vent 14 and the intake port 12. The mosquitoes 30 instinctively fly upward as they are pulled into the intake port 12 by the airflow from the fan 28. The intake 12 vacuums the mosquitoes 30 up and hurdles them into the liquid mixture in the cup 22 where they drown. Those that escape the liquid are pulled up and thrown into the adhesive 32 located on the J-shaped base 24. This adhesive may be glue applied directly on the base 24, or as a double sticky paper with one side mounted on the base 24 and the other side facing out to catch the mosquitoes 30. In either case it may be desirable to include a “peel off” paper to be removed by the user just prior to use. Any mosquitoes 30 that make it through both of these traps are run through the blades of the fan 28. A typical fan speed is 5000 rpm. Once they go in the device 10, they do not come out alive.

The mosquitoes 30 that are captured in either of the two traps, the liquid in the cup 22 or the glue 32, are removed with the cup 22 and discarded prior to the device 10 being used again. This removal of the dead insects helps keep the device 10 clean. For the subsequent use, a new cup 22 is filled with the appropriate liquid (water or acid) and the glue 32 may be exposed, if necessary, by removing any protective paper. The cup 22 is then placed in the frame of the device 10 through the door 34. The device 10 is then turned on by a switch (not shown) of a type that is common to the art of electrical switches. This activates the fan 28 and light 26. The liquid added to the carbonic compound located in the cup, reacts to produce a gas that is noted by the flow arrows 36. In areas near the traps, the frame walls are directed toward the traps thereby narrowing in width. This venturi affect may be used to accelerate the airflow and insects 30 in the air, into the traps of the cup 22 or the glue 32.

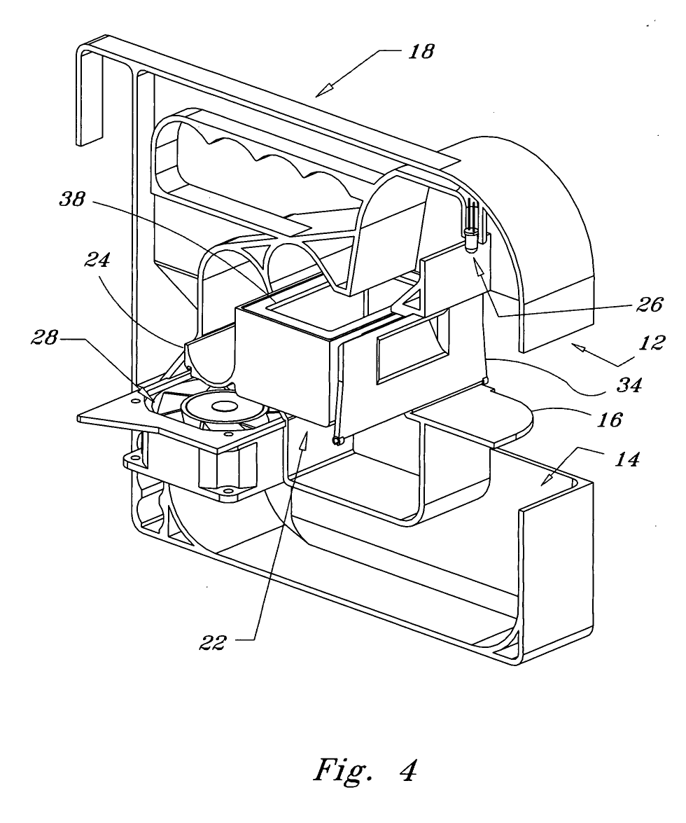

The left side of the frame has been removed in FIG. 4, thereby more clearly illustrating the function and structure of the device 10 and the critical elements. The light 26 may be a green or blue LED. A LED may be used due to its greater efficiency as compared to an incandescent light. LED's can produce a 9200 mcd intensity light at 5 VDC and a 30 mA current draw. The fan 28 is likely the larger energy consumer, and can run on 12 VDC producing 24 CFM @ 0 psi with a 5000 rpm rotation speed. With these two elements providing the majority of the power consumption of the device 10, it is easily suited to run on batteries. A timer (not shown) can be used to limit the cycle time to any predetermined time period such as 4 hours. This is to prolong battery life of the unit. With this system, eight AA batteries may last 95 hours or approximately twenty-four sessions of four hours each.

Another attractant is heat. Heat may be added by providing a heating element to heat the exhausting air/gas combination. This would require a great deal more energy. Larger batteries and a shorter battery life would result or the device 10 would need to be run from an AC outlet. This reduction in mobility or battery life may be less valuable than the addition of the additional attractant (heat) and is therefore not illustrated though it is understood that this or other attractant features may be added. The inventor acknowledges the potential advantage of the addition and considers any heating element commonly known in the art to be an inherent addition to the disclosure.

Also shown in FIG. 4, the cup 22 is shown here to include a splash ring 38 on the upper perimeter of the cup 22. The splash ring 38 has three functions. First, the ring 38 is preferably press fit onto the cup 22. This seals the mating edge of the cup 22 and the ring 38, preventing leakage in that the ring 38 prevents liquid in the cup 22 from spilling out over the side of the cup 22 when the device 10 is moved with liquid in the cup 22. The ring 38 may also function as a “cap” in that the inside dimensions of the ring 38 may be smaller than the outside dimensions of the tablet of carbonic mixture that is housed in the cup 22. This prevents the tablet of reactants from inadvertently exiting the cup 22 prior to use. Finally, the ring 38 acts to provide turbulent airflow at the surface of the cup 22. This turbulent flow aids in the mosquitoes being deposited and retained in the liquid trap in the cup 22.

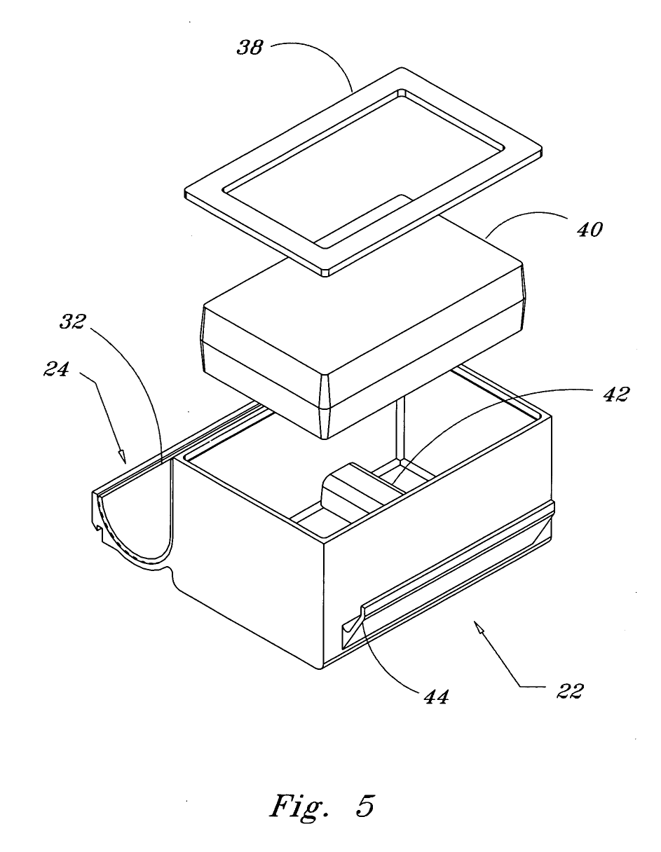

The cup 22 with the tablet 40 and splash ring 22 is shown in FIG. 5. In this form the tablet 40 is shown as a compressed form of the carbonic compound alone or a mixture of the compound and dry or anhydrous acid. In either case, with the addition of the specified liquid (acid or water respectively), carbon dioxide, water vapor and some airborne acid will be given off. The tablet 40 may be compressed to prolong the reaction or a loose powder may be coated or placed in a semi-permeable container such as a perforated plastic bag. If a compressed tablet is used, the outside layer reacts in the presence of the liquid, producing a precipitating material that is eroded off the tablet 40 to reveal new reactants on this the new outer surface, and the process continues. The ridges 42 in the cup 22 are to elevate and therefore help maintain a constant fluid contact with the tablet 40 to provide a continuous reaction away from the precipitant produced by the reaction. Multiple ridges 42 may also be used, or also a mesh or screen comprising a plurality of ridges, allowing any precipitant produced to be displaced by gravity away from the reactants in the tablet 40. The J-shaped base 24 is also shown with the glue 32 positioned thereon. A handle 44 is also provided to assist in the removal and placement of the cup 22 in and out of the device 10.

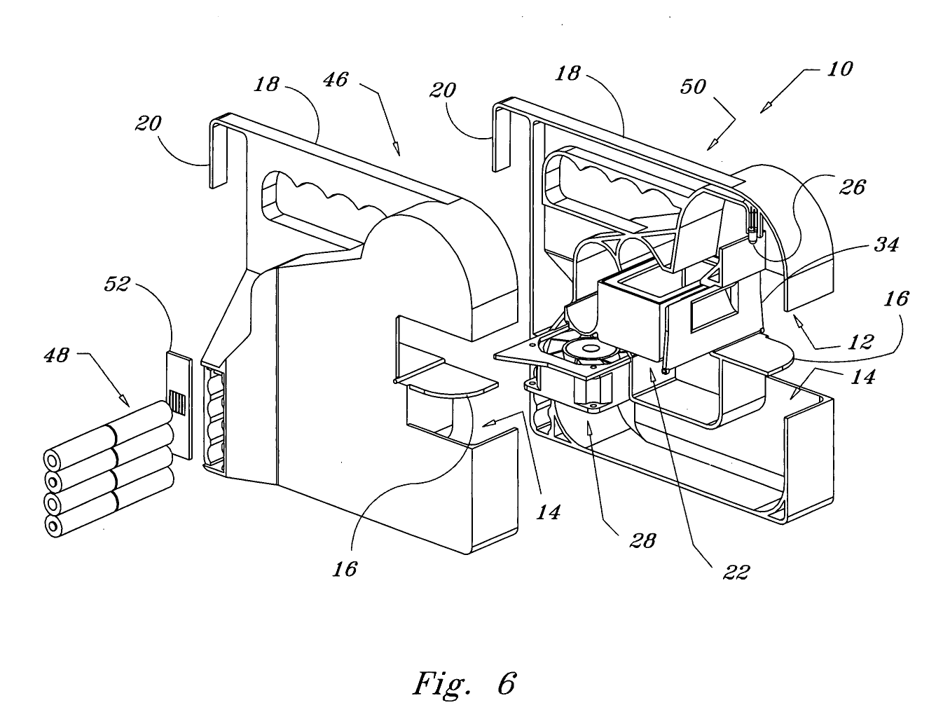

FIG. 6 shows the device 10 with the left side 46 and batteries 48 displaced. The door 34, cup 22 and motor 28 are left in the right side 50 to show their position in the device 10. The hook 20 (shown here in two parts, one on each side of the frame (46 & 50)) on the back of the device 10 may be used to hang the device 10 on a fence or other structure. The batteries 48 have also been displaced to better show their use in the device 10. The batteries 48 are received by the frame of the device 10, by way of the battery door 52. The handle 18 is also divided between the two sides of the frame and is used to facilitate moving and placement of the device 10. The compact nature of the device 10 may be very desirable in this embodiment. For example, in this current state the total unit has a weight of approximately 1.9 lbs (without the liquid). The frame can be constructed of approximately 1.31 pounds of plastic or similar material.

Unlike much of the prior art that uses propane to generate CO₂, this device 10 may be used indoors. A user can place the device 10 across the room when they go to bed. If an unwanted flying pest sneaks in, the device 10 offers a seemingly attractive “meal potential” away from the user. In the off-season the device 10 may be used as a CO₂ generator for indoor plants.

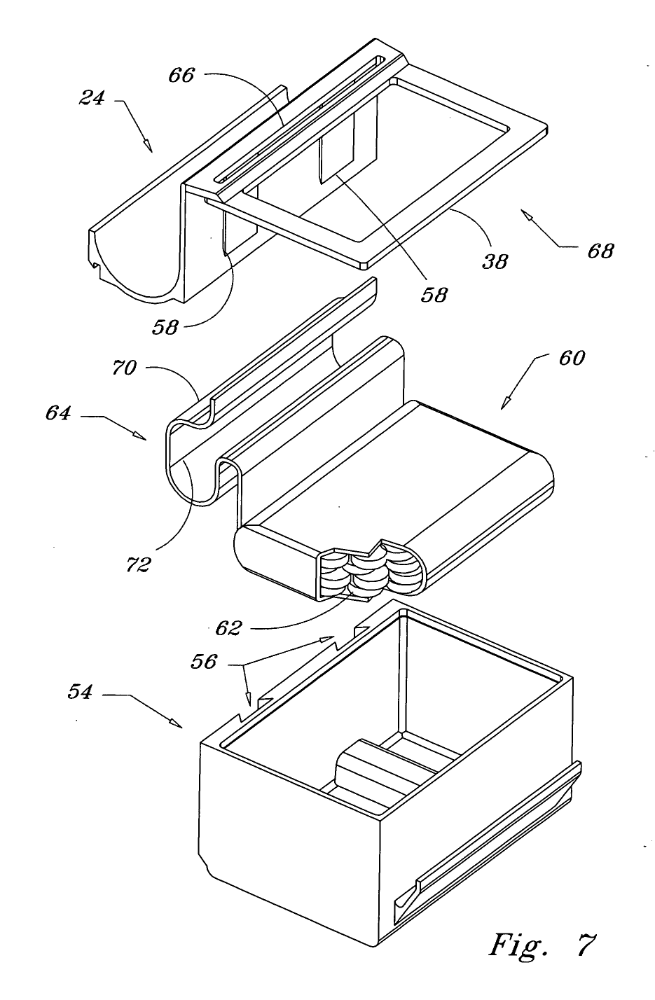

An alternative cup 54 is illustrated in FIG. 7. The “J” shaped base 24 has been removed from the cup 54 and is joined to the splash ring 38. A pair of grooves 56 are placed in the alternative cup 54, enabling receipt of similar shaped fingers 58. In this form the replaceable cartridge consists of the bag 60 filled with the reactants in the form of small tablets or capsules 62. In this form, the reactants may be a plurality of smaller tablets or capsules 62 (as is shown here), a block 40 as previously noted, or powder. The material of the bag 60 may be a semi-permeable membrane that allows water to penetrate and react with the chemical reactants inside the bag 60. The permeability of the bag 60 to the fluid may be such that the reaction may be slowed to provide the 3-4 hour timed release of the reactants to fully react in water or other fluid. In this form, the tablets 62 may also be coated with a water retarding material to slow the reaction of some of the tablets 62. A portion of the tablets 62 can be uncoated, a portion lightly coated and another portion heavily coated. These are then randomly mixed within the bag 60 to also facilitate a steady timed release of carbon dioxide from the stepped reaction process of the coated tablets 62. In this illustration the bag 60 has been partially removed to show the tablets 62 located therein.

A free lip 64 of the bag 60 is passed through a slot 66 in the top cap 68. The free lip may be made of the same material as the bag 60, and would therefore be an extension thereof. This is not necessary to the function of the device 10 but may be preferable in that this potentially reduces production costs. The free lip 64 may include an adhesive on both sides of the lip 64. A light adhesive may be applied to the first side 70 and a heavy adhesive is applied to the second side 72. One or both sides may be covered with a release paper to prevent contamination of the adhesive to oils and debris prior to use. The first side 70 is mounted to the “J” shaped base 24 and held in place by the light adhesive. The heavy adhesive is then facing up to catch the mosquitoes that are forced into the adhesive. In this form of the invention, the only article that is discarded by the user after a cycle is the bag 60 and any remaining contents therein. This potentially reduces the size and cost of the replacement cartridges.

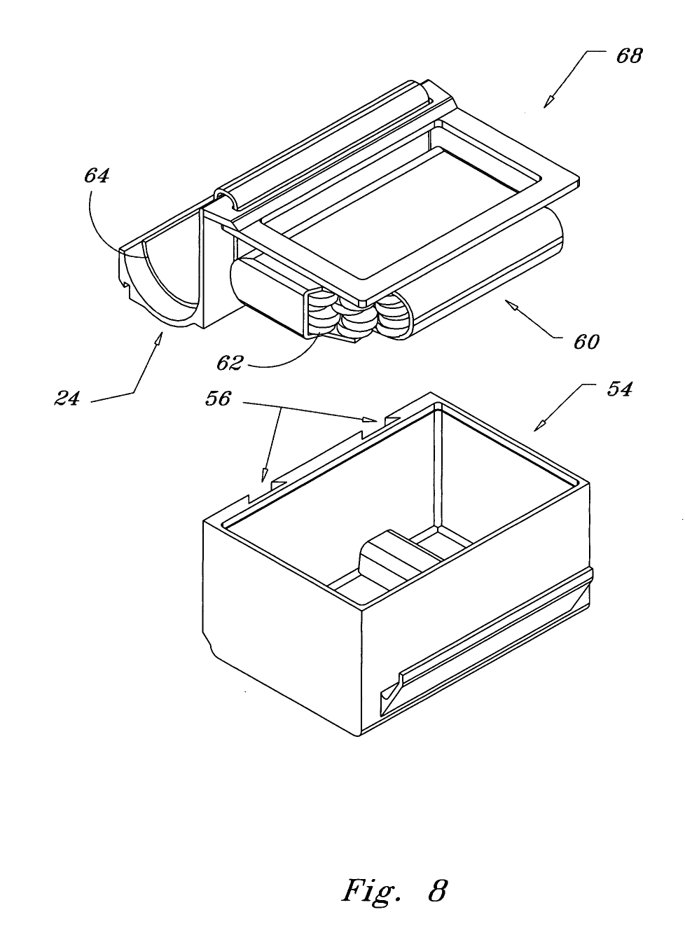

In FIG. 8, the bag 60 with the tablets 62, may be assembled to the top cap 68 as the user would do prior to placing in the cup with the appropriate fluid (water or acid). The free lip 64 is releasably mounted to the “J” shaped base 24 and the bag 60 with the top cap 68 are placed in the cup 54. The grooves 56 lock the top cap 68 to the cup 54 until a cycle is completed and the bag 60 is removed.

As noted throughout this disclosure the reactants may be comprised of an acid and a carbonic base in dry form where water is added to initiate the chemical reaction, or the carbonic base may be one tablet or group of tablets and an aqueous acid solution may be added to start the chemical reaction. A carbon dioxide molecule is approximately 1 μm (1×10⁻⁶ m) across. A water molecule is actually much smaller (approximately 0.29 nm (2.9×10⁻¹⁰ m)) across but do to hydrogen bonding, water molecules tend to group together forming weak bonds creating larger droplets. Therefore, a water filter may have pores in excess of 0.021 inches (5×10⁻⁴ m) in diameter. The reactants may be packaged together in a dry form in semi-permeable container and water added to start the reaction. In doing so the smaller the pore size of the semi-permeable container the greater the restriction to flow of the water or other fluid to cross the semi-permeable boundary. This would slow any reaction between the reactants. On the other hand, a larger pore size would allow an increased rate of flow of the fluid, thus increasing the rate of the reaction. Therefore a semi-permeable container can be used to control the rate of reaction. As previously noted one or more polymer coatings may also be used to cover some or all of the reactants. This coating would also act as a semi-permeable container in that it provides a temporary barrier for the reactants.

Another method of accomplishing this would be to substitute the tablet 40 with a pliable container that includes one or more sub-containers of aqueous acid and one or more sub-containers of the carbonic compound(s). The pore size of the semi-permeable container may be large enough to allow the carbon dioxide to pass but not the aqueous solution and precipitant of the solid matter as a byproduct of the reaction. By doing so a user could deform the pliable container that may look similar to the tablet 40 in FIG. 5 with two large sub-containers therein, or the container “bag” 60 in FIG. 7 containing many sub-containers. By rupturing the sub-containers, the contents would mix and initiate the chemical reaction. The CO₂ would be able to be released while the liquid and solids of the reactants may remain in the semi-permeable container.

The foregoing detailed description of the present invention is provided for purposes of illustration, and it is not intended to be exhaustive or to limit the invention to the particular embodiment shown. The embodiments may provide different capabilities and benefits, depending on the configuration used to implement key features of the invention.

What is claimed is:

1. An insect snare comprising:
a frame with an intake port and an exhaust vent;
a fan providing airflow from the intake port to the exhaust vent;
a trap positioned in a path between the intake port and the exhaust vent; and
an attractant including a mixture of a carbonic compound and an acid housed within a semi-permeable container, thus prolonging a reaction between the carbonic compound and the acid.

2. An insect snare as in claim 1, wherein the trap is comprised of a trap selected from the group consisting of a glue trap and a fluid trap positioned in a path between the intake port and the exhaust vent.

3. An insect snare as in claim 1, wherein the trap includes a cup adapted to receive a liquid.

4. An insect snare as in claim 3, wherein the cup includes a splash ring on an open end of the cup, wherein the splash ring reduces a dimension of the open end of the cup.

5. An insect snare as in claim 1, wherein the carbonic compound and the acid are in a dry form.

6. An insect snare as in claim 1, wherein the carbonic compound includes a compound selected from the group consisting of sodium carbonate, sodium bicarbonate and calcium carbonate.

7. An insect snare as in claim 1, wherein the acid includes an acid selected from the group consisting of lactic acid, pyruvic acid, citric acid, oxaloacetic acid, 7-octenoic acid and 2-oxopentanoic acid.

8. An insect snare as in claim 1, further comprising a light substantially near the intake port.

9. An insect snare as in claim 8, wherein the light is a light emitting diode (LED).

10. An insect snare as in claim 8, wherein the light provides a light of a color selected from the group including white, green and blue.

11. An insect snare as in claim 1, wherein the frame includes a hook adapted to support the weight of the insect snare.

12. An insect snare as in claim 1, wherein the semi-permeable bag further includes an adhesive on a surface thereof.

13. An insect snare as in claim 1, wherein the carbonic compound is housed in a first container and the acid is housed in a second container, both the first and second containers contained in the semi-permeable container.

14. The insect snare as in claim 13, wherein the semi-permeable container is permeable to carbon dioxide gas but not to water.

15. The insect snare as in claim 13, wherein the first container is a chemical coating.

16. The insect snare as in claim 1, wherein the semi-permeable container is permeable to water.

17. An insect snare comprising:
a carbonic mixture housed within a semi-permeable container;
a cup adapted to receive the carbonic mixture;
a frame supporting the cup, the frame including an intake port and an exhaust vent; and
an airflow generator providing airflow from the intake port to the exhaust vent.

18. An insect snare as in claim 17, wherein the carbonic mixture includes an anhydrous acid.

19. An insect snare as in claim 17, wherein the carbonic mixture includes an acid selected from the group consisting of lactic acid, pyruvic acid, citric acid, oxaloacetic acid, 7-octenoic acid and 2-oxopentanoic acid.

20. An insect snare as in claim 17, wherein the carbonic mixture is the form of a tablet.

21. An insect snare as in claim 20, wherein the tablet reacts with water at 21 degrees Celsius and one atmosphere of pressure for a substantially continuous period of at least two hours.

22. An insect snare as in claim 17, wherein the carbonic mixture is comprised of chemical reactants housed within a bag manufactured of a semi-permeable material.

23. An insect snare as in claim 17, wherein the intake port is positioned substantially above the exhaust vent.

24. An insect snare as in claim 17, further comprising a glue trap including an adhesive surface.

25. An insect snare as in claim 17, wherein the carbonic mixture includes a compound selected from the group consisting of sodium carbonate, sodium bicarbonate and calcium carbonate.

26. An insect snare as in claim 17, wherein said carbonic mixture is comprised of sodium bicarbonate and lactic acid.

27. An insect snare as in claim 17, further comprising a light disposed substantially near the intake port.

28. An insect snare as in claim 27, wherein the light is a light emitting diode (LED).

29. An insect snare as in claim 27, wherein the light provides a light of a color selected from the group including white, green and blue.

30. An insect snare as in claim 17, wherein the cup includes a trap selected from the group consisting of a glue trap and a fluid trap.

31. An insect snare as in claim 17, wherein said airflow generator is comprised of a fan.

32. An insect snare as in claim 17, wherein the carbonic compound is housed in a first container and the acid is housed in a second container, both the first and second containers contained in the semi-permeable container.

33. The insect snare as in claim 32, wherein the semi-permeable container is permeable to carbon dioxide gas but not to water.

34. The insect snare as in claim 32, wherein the second container is a chemical coating.

35. The insect snare as in claim 17, wherein the semi-permeable container is permeable to water.

36. For use with an insect snare device including a carbonic mixture, a cup adapted to receive the carbonic mixture housed in a semi-permeable container, a frame including an intake port and an exhaust vent and supporting the cup, and an airflow generator providing airflow from the intake port to the exhaust vent, a method of capturing flying insects comprising the steps of:
combining a liquid and the carbonic mixture in the cup;
placing the cup in the frame of the device; and
actuating the airflow generator.

37. A method as in claim 32, wherein said device further includes a light positioned substantially near said intake port, the method further including the step of:
illuminating the light.
